(19) United States
(12) Patent Application Publication
(10) Pub. No.: US 2004/0021300 A1
(43) Pub. Date: Feb. 5, 2004

(54) Foldable wheelchair

(76) Inventor: Ruey Yun Tsai, Taichung (TW)

Correspondence Address: Ruey Yun Tsai, No. 1, Alley 16, Lane 40, Jinn Te Road, Taichung, TW

(21) Appl. No.: 10/212,648

(22) Filed: Aug. 2, 2002

(51) Int. Cl. B62B 1/00

(52) U.S. Cl. 280/642

(57) ABSTRACT

A foldable wheelchair includes a seat frame having a front side provided with a foot frame, a rear side provided with two push handles, and a bottom side provided with two wheel frames. In assembly, each of the foot frame, the two push handles and the two wheel frames is pivotally mounted on the seat frame, and may be folded and positioned on one side of the seat frame. Thus, when the wheelchair is expanded, the seat frame may form a receiving space for placing and storing articles therein. In addition, each of the two push handles and the foot frame may be folded, so that the wheelchair may function as a portable suitcase by the telescopic pull bar and the wheel frames, thereby facilitating the user carrying the wheelchair.

### BACKGROUND OF THE INVENTION

1. Field of the Invention

The present invention relates to a foldable wheelchair, and more particularly to a foldable wheelchair, wherein when the wheelchair is expanded, the seat frame may form a receiving space for placing and storing articles therein.

2. Description of the Related Art

A conventional foldable wheelchair in accordance with the prior art is disclosed in the Taiwanese Patent Publication No. 248047; 257066; and 11 261771. However, after the wheelchair is folded, the whole height of the wheelchair is fixed and cannot be adjusted, so that the folded wheelchair will occupy a larger space, thereby causing inconvenience in storage and transportation.

### SUMMARY OF THE INVENTION

The present invention has arisen to mitigate and/or obviate the disadvantage of the conventional foldable wheelchair.

The primary objective of the present invention is to provide a foldable wheelchair, wherein when the wheelchair is expanded, the seat frame may form a receiving space for placing and storing articles therein.

Another objective of the present invention is to provide a foldable wheelchair, wherein each of the two push handles and the foot frame may be folded, so that the wheelchair may function as a portable suitcase by the telescopic pull bar and the wheel frames, thereby facilitating the user carrying the wheelchair.

A further objective of the present invention is to provide a foldable wheelchair, wherein the telescopic pull bar and each of the two wheel frames may be folded, so that the wheelchair may function as a storage case for storing and placing articles.

In accordance with the present invention, there is provided a foldable wheelchair, comprising a seat frame having a front side provided with a foot frame, a rear side provided with two push handles, and a bottom side provided with two wheel frames, wherein:

each of the foot frame, the two push handles and the two wheel frames is pivotally mounted on the seat frame, and may be folded and positioned on one side of the seat frame, and the seat frame is formed with a receiving space with an opening facing upward.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a foldable wheelchair in accordance with a preferred embodiment of the present invention;

FIG. 2 is a side plan view of the foldable wheelchair as shown in FIG. 1;

FIG. 3 is a schematic operational view of the foldable wheelchair as shown in FIG. 1, wherein the push handle is folded;

FIG. 4 is a partially cut-away plan cross-sectional view of the foldable wheelchair as shown in FIG. 1, wherein the push handle is folded;

FIG. 4A is a partially cut-away plan cross-sectional view of the foldable wheelchair as shown in FIG. 1, wherein the push handle is folded;

FIG. 5 is a plan cross-sectional view of a pivot structure of the foldable wheelchair as shown in FIG. 1;

FIG. 6 is a schematic operational view of the foldable wheelchair as shown in FIG. 3, wherein the foot frame is folded;

FIG. 7 is a schematic operational view of the foldable wheelchair as shown in FIG. 6, wherein the telescopic pull bar is pulled outward;

FIG. 8 is a side plan view of the foldable wheelchair as shown in FIG. 7; and

FIG. 9 is a schematic operational view of the foldable wheelchair as shown in FIG. 6, wherein the wheel frame is pulled outward.

### DETAILED DESCRIPTION OF THE INVENTION

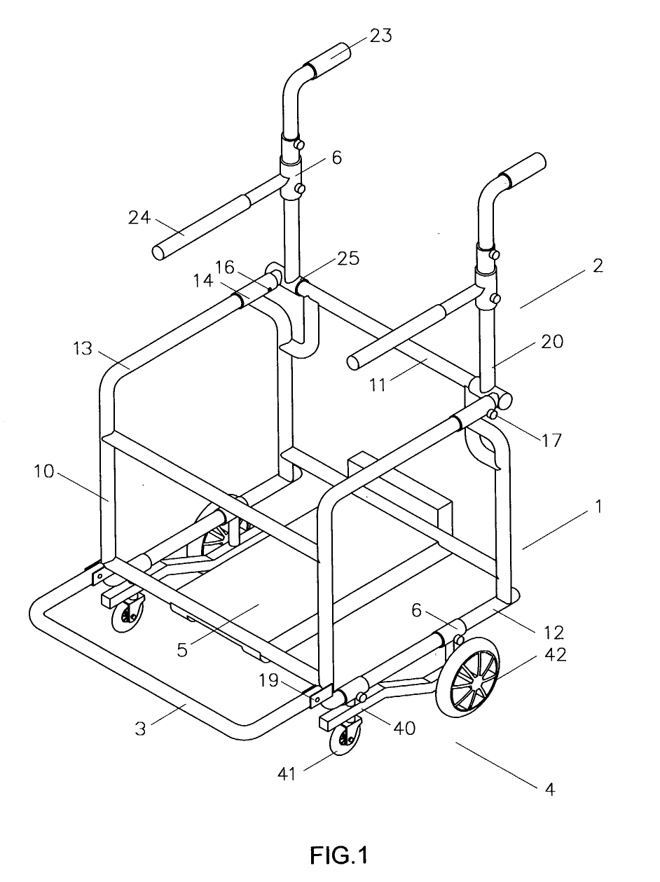

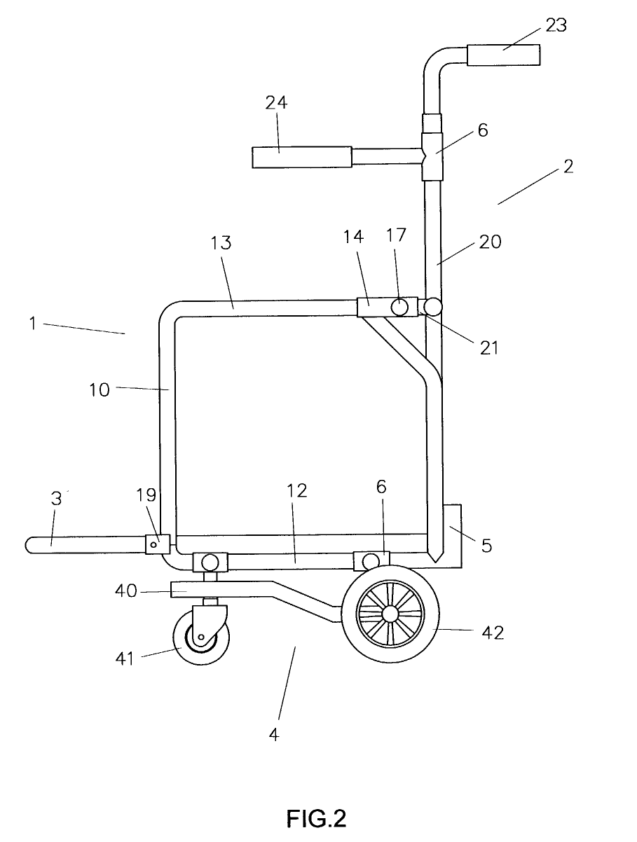

Referring to the drawings and initially to FIGS. 1 and 2, a foldable wheelchair in accordance with a preferred embodiment of the present invention comprises a seat frame 1, two push handles 2, a foot frame 3, and two wheel frames 4.

The seat frame 1 includes multiple steel tubes that are soldered together to form a cubic support frame. A jacket (not shown) may be mounted on the seat frame 1, thereby forming a storage space. The seat frame 1 has a top side having a rear portion provided with a transverse rod 11 having two ends, and each of the two push handles 2 is pivotally mounted on one of the two ends of the transverse rod 11 of the seat frame 1. The seat frame 1 has a front side provided with two vertical support rods 10 each having a lower end provided with a pivot seat 19, and the foot frame 3 has two ends each pivotally mounted on the pivot seat 19 of one of the two vertical support rods 10 of the seat frame 1. The seat frame 1 has a bottom side provided with two bottom side rods 12, and each of the two wheel frames 4 is pivotally mounted on one of the two bottom side rods 12 of the seat frame 1. The top side of the seat frame 1 is provided with two top side rods 13 each having one end provided with a positioning plate 14 for locking and positioning each of the two push handles 2.

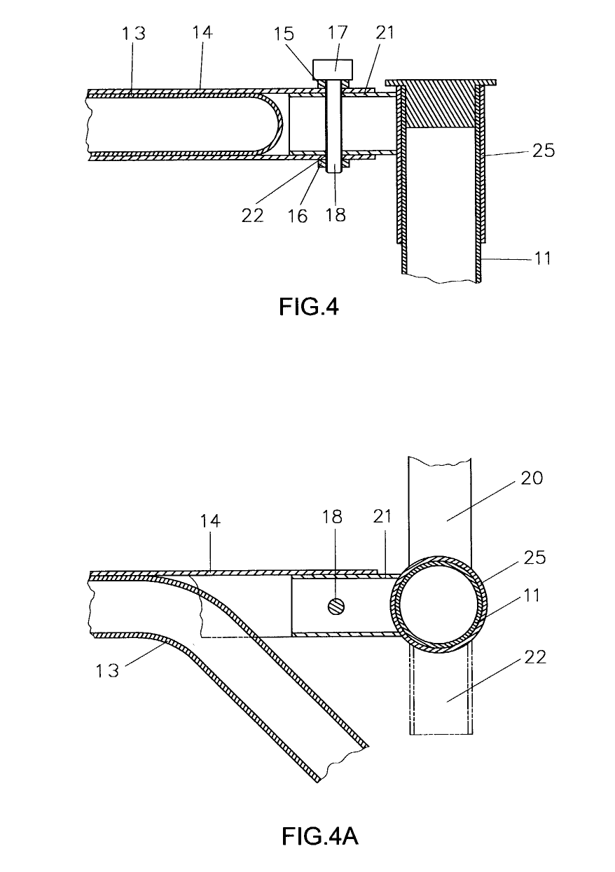

As shown in FIGS. 1, 4 and 4A, the positioning plate 14 has two sides each formed with a through hole 15 which is secured with a nut 16 by soldering. A positioning knob 17 has a threaded rod 18 screwed into the nut 16 for fixing each of the two push handles 2.

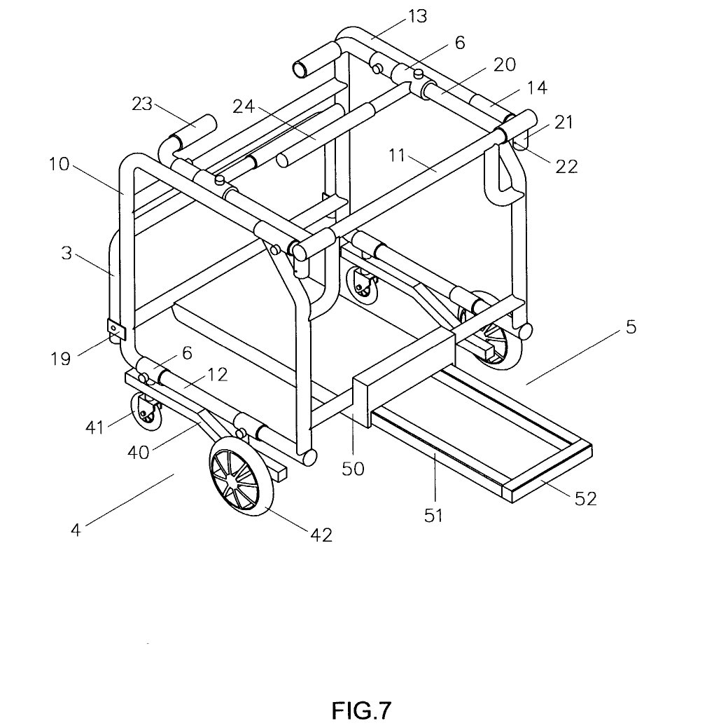

As shown in FIGS. 1 and 7, the bottom side of the seat frame 1 is provided with a telescopic pull bar 5. The telescopic pull bar 5 includes a seat body 50 secured on the bottom side of the seat frame 1, two retractable bars 51 each telescopically mounted in the seat body 50, and a handgrip 52 secured on a distal end of each of the two retractable bars 51.

Each of the two push handles 2 is pivotally mounted on one of the two ends of the transverse rod 11 of the seat frame 1 by a pivot sleeve 25. A backrest pad (not shown) may be mounted between the two push handles 2. The pivot sleeve 25 of each of the two push handles 2 is provided with a seat tube 20 and a positioning rod 21 vertical to the seat tube 20. Each of the two push handles 2 includes a handlebar 23 and an armrest 24 each pivotally mounted on the seat tube 20 by a pivot structure 6, so that the handlebar 23 and the armrest 24 may be retracted, displaced and rotated on the seat tube 20, thereby facilitating folding of the handlebar 23 and the armrest 24.

As shown in FIG. 4, the positioning rod 21 of each of the two push handles 2 is formed with a positioning hole 22 aligning with the through hole 15 of the positioning plate 14 for passage of the threaded rod 18 of the positioning knob 17. Thus, when the threaded rod 18 of the positioning knob 17 is screwed to extend through the positioning hole 22 of the positioning rod 21 of each of the two push handles 2, the positioning rod 21 of each of the two push handles 2 may be fixed and positioned by the threaded rod 18 of the positioning knob 17.

The foot frame 3 is made of a substantially U-shaped steel tube, and has two ends each pivotally mounted on the pivot seat 19 of one of the two vertical support rods 10 of the seat frame 1.

Each of the two wheel frames 4 is pivotally mounted on one of the two bottom side rods 12 of the seat frame 1 by a pivot structure 6. Each of the two wheel frames 4 includes a wheel seat 40 having a front end pivotally provided with a front wheel 41 and a rear end pivotally provided with a rear wheel 42.

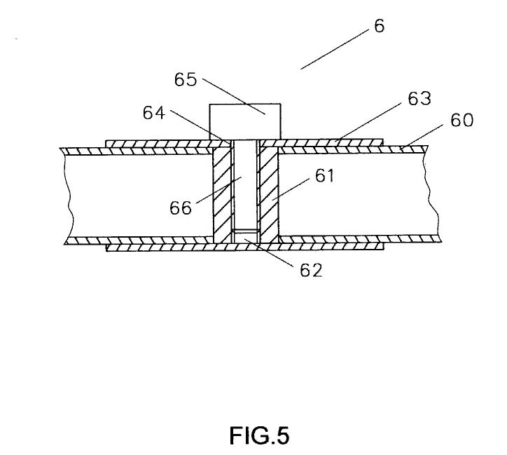

As shown in FIG. 5, the pivot structure 6 includes an inner tube 60, and an outer tube 63 mounted on the inner tube 60. The inner tube 60 of the pivot structure 6 is provided with a threaded block 61 which is formed with a screw bore 62 which is extended to an outside of the inner tube 60 of the pivot structure 6. The outer tube 63 of the pivot structure 6 is formed with a through hole 64 aligning with the screw bore 62 of the threaded block 61 of the inner tube 60 of the pivot structure 6. A knob 65 is mounted on the outer tube 63 of the pivot structure 6, and has a threaded rod 66 extended through the through hole 64 of the outer tube 63 of the pivot structure 6 and screwed into the screw bore 62 of the threaded block 61 of the inner tube 60 of the pivot structure 6, thereby achieving the locking and positioning purpose.

In practice, the inner tube 60 of the pivot structure 6 may be one of the two bottom side rods 12 of the seat frame 1. In addition, the inner tube 60 of the pivot structure 6 may also be the seat tube 20 or the handlebar 23 of each of the two push handles 2. The outer tube 63 of the pivot structure 6 may be provided on each of the two wheel frames 4. In addition, the outer tube 63 of the pivot structure 6 may also be provided on the armrest 24 of each of the two push handles 2. Further, the outer tube 63 of the pivot structure 6 may also be the seat tube 20 of each of the two push handles 2.

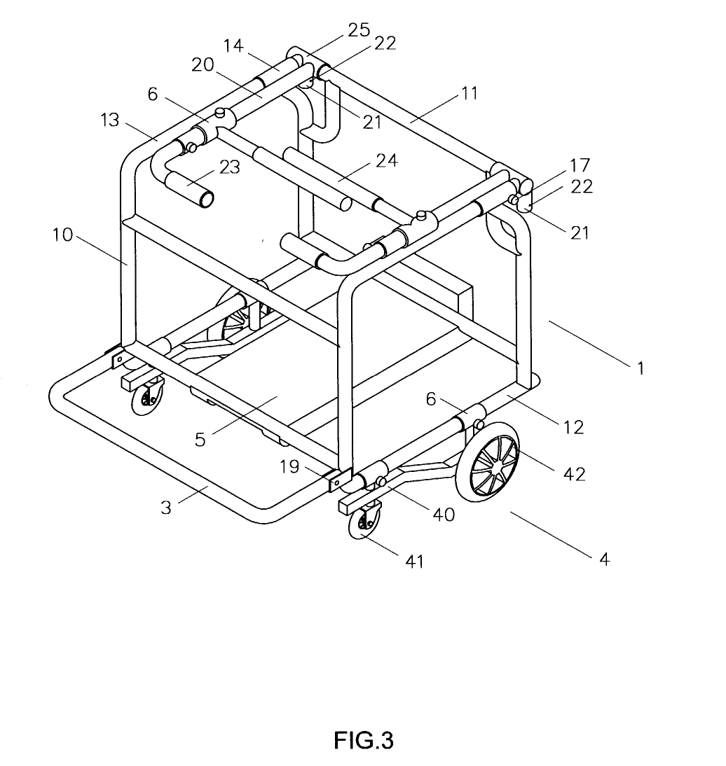

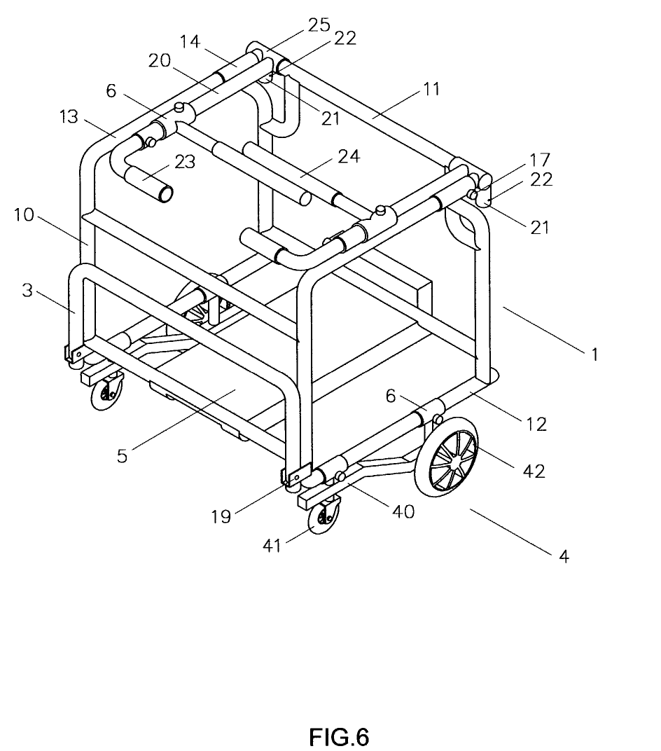

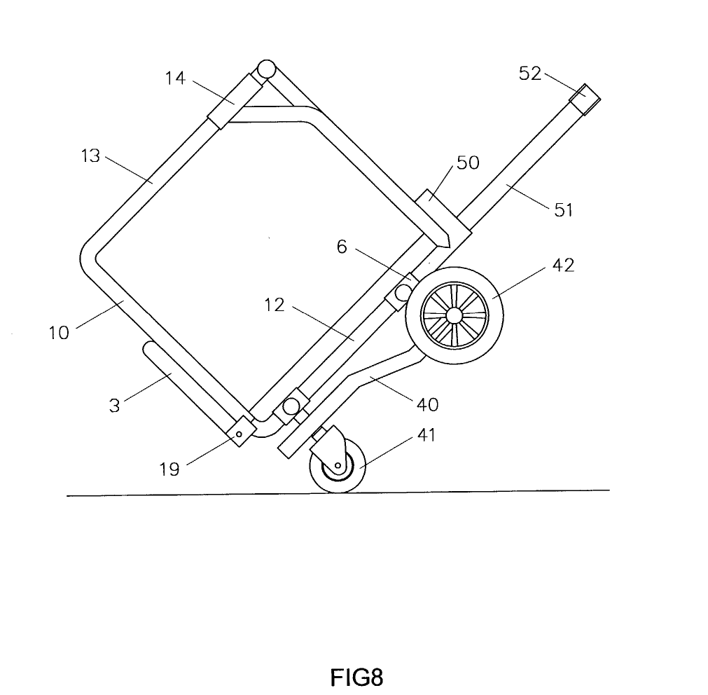

When the user wishes to fold the wheelchair, by using the pivot structure 6, the handlebar 23 and the armrest 24 of each of the two push handles 2 may be rotated and fixed on one side. Then, the positioning knob 17 may be unscrewed outward to detach from the positioning hole 22 of the positioning rod 21 of each of the two push handles 2, so that each of the two push handles 2 may be rotated forward to abut the top side of the seat frame 1 as shown in FIG. 3. Then, the foot frame 3 may be pivoted upward to press the front side of the seat frame 1 as shown in FIG. 6. Then, the handgrip 52 of the telescopic pull bar 5 may be pulled outward from the seat body 50 as shown in FIG. 7, so that the wheelchair may function as a suitcase, thereby facilitating the user carrying the wheelchair like a suitcase as shown in FIG. 8.

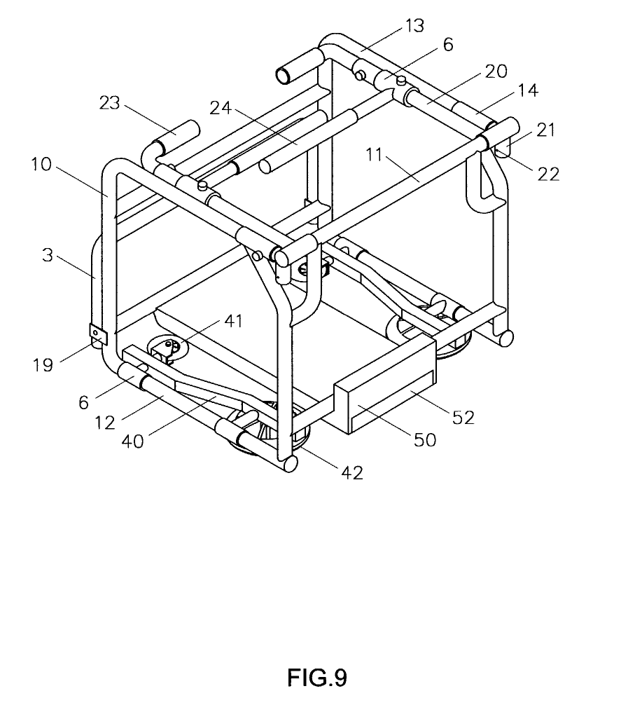

Alternatively, by using the pivot structure 6, each of the two wheel frames 4 may be pivoted to press the bottom side of the seat frame 1, so that the wheelchair may function as a storage case as shown in FIG. 9 for storing and placing articles. A leather jacket (not shown) may be mounted on the outside of the folded wheelchair, thereby enhancing the aesthetic quality of the wheelchair.

Accordingly, the foldable wheelchair in accordance with the preferred embodiment of the present invention has the following advantages.

When the wheelchair is expanded, the seat frame 1 may form a receiving space for placing and storing articles therein. In addition, each of the two push handles 2 and the foot frame 3 may be folded, so that the wheelchair may function as a portable suitcase by the telescopic pull bar 5 and the wheel frames 4, thereby facilitating the user carrying the wheelchair. Further, the telescopic pull bar 5 and each of the two wheel frames 4 may be folded, so that the wheelchair may function as a storage case for storing and placing articles.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A foldable wheelchair, comprising a seat frame having a front side provided with a foot frame, a rear side provided with two push handles, and a bottom side provided with two wheel frames, wherein:
each of the foot frame, the two push handles and the two wheel frames is pivotally mounted on the seat frame, and may be folded and positioned on one side of the seat frame, and the seat frame is formed with a receiving space with an opening facing upward.

2. The foldable wheelchair in accordance with claim 1, wherein the seat frame has a top side provided with two top side rods each having one end provided with a positioning plate for locking and positioning each of the two push handles, and the positioning plate is provided with a positioning knob for fixing each of the two push handles.

3. The foldable wheelchair in accordance with claim 1, wherein the bottom side of the seat frame is provided with a telescopic pull bar, and the telescopic pull bar includes a seat body secured on the bottom side of the seat frame, two retractable bars each telescopically mounted in the seat body, and a handgrip secured on a distal end of each of the two retractable bars.

4. The foldable wheelchair in accordance with claim 1, wherein the seat frame has a top side having a rear portion provided with a transverse rod having two ends, each of the two push handles is pivotally mounted on one of the two ends of the transverse rod of the seat frame, a backrest pad may be mounted between the two push handles, each of the two push handles is provided with a positioning rod that may be positioned on the positioning plate of the seat frame, and each of the two push handles includes a handlebar and an armrest.

5. The foldable wheelchair in accordance with claim 4, wherein each of the two push handles is provided with a seat tube, and each of the handlebar and the armrest is pivotally mounted on the seat tube of each of the two push handles by a pivot structure.

6. The foldable wheelchair in accordance with claim 5, wherein the pivot structure includes an inner tube in the form of the seat tube of each of the two push handles, and an outer tube provided on the armrest of each of the two push handles and mounted on the inner tube, the inner tube of the pivot structure is provided with a threaded block which is formed with a screw bore which is extended to an outside of the inner tube of the pivot structure, the outer tube of the pivot structure is formed with a through hole aligning with the screw bore of the threaded block of the inner tube of the pivot structure, a knob is mounted on the outer tube of the pivot structure, and has a threaded rod extended through the through hole of the outer tube of the pivot structure and screwed into the screw bore of the threaded block of the inner tube of the pivot structure.

7. The foldable wheelchair in accordance with claim 1, wherein each of the two wheel frames is pivotally mounted on the seat frame by a pivot structure.

8. The foldable wheelchair in accordance with claim 7, wherein the bottom side of the seat frame is provided with two bottom side rods, and the pivot structure includes an inner tube in the form of each of the two bottom side rods of the seat frame, and an outer tube provided on each of the two wheel frames and mounted on the inner tube, the inner tube of the pivot structure is provided with a threaded block which is formed with a screw bore which is extended to an outside of the inner tube of the pivot structure, the outer tube of the pivot structure is formed with a through hole aligning with the screw bore of the threaded block of the inner tube of the pivot structure, a knob is mounted on the outer tube of the pivot structure, and has a threaded rod extended through the through hole of the outer tube of the pivot structure and screwed into the screw bore of the threaded block of the inner tube of the pivot structure.

9. The foldable wheelchair in accordance with claim 1, wherein the front side of the seat frame is provided with two vertical support rods each having a lower end provided with a pivot seat, and the foot frame has two ends each pivotally mounted on the pivot seat of one of the two vertical support rods of the seat frame.

10. The foldable wheelchair in accordance with claim 2, wherein the positioning plate has two sides each formed with a through hole which is secured with a nut, and the positioning knob has a threaded rod screwed into the nut for fixing each of the two push handles.
